(19) United States
(12) Patent Application Publication
(10) Pub. No.: US 2004/0217136 A1
(43) Pub. Date: Nov. 4, 2004

(54) Dispenser bottle

(76) Inventors: Jun Lu, Shanghai (CN); Christine Andrea Ruhotas, Bexley (AU); Xiaohai Lu, Shanghai (CN); Min Xu, Shanghai (CN)

Correspondence Address: PHILIP S. JOHNSON, JOHNSON & JOHNSON, ONE JOHNSON & JOHNSON PLAZA, NEW BRUNSWICK, NJ, 08933-7003, US

(21) Appl. No.: 10/462,204

(22) Filed: Jun. 16, 2003

(30) Foreign Application Priority Data
Apr. 30, 2003 (CN) 03136055.6

(51) Int. Cl. B67D 3/00

(52) U.S. Cl. 222/480

(57) ABSTRACT

The present invention relates to a low cost dispenser container for containing and selectively dispensing a flowable material comprising a body portion having a filling end and an apertured dispensing end; a base plate; and an apertured cap, wherein the apertured cap is engaged with the apertured dispensing end of said body portion, and the base plate is secured to the filling end of the body portion after the body portion is filled with the desired amount of flowable material.

This application claims the priority benefit of Chinese Patent Application Number N/A (Attorney Docket Number CPME 0341431), filed Apr. 30, 2003, which is hereby incorporated by reference herein.

### BACKGROUND OF THE INVENTION

1. Field of the Invention

The present invention relates to an improvement in a container for dispensing flowable material such as powders or finely ground fibers as, for example, talc, body portion powders, baby powders, cosmetic face powders, soap powders, infant formulas, and the like. In particular, this invention is directed toward the design and method of assembling of a container that is not only more economically beneficial to manufacture, but also simple to fill.

2. Description of the Prior Art

Commercially available dispensers for flowable material typically comprise a body portion for containing the powder and a cap for dispensing the powder. The body portion has an open mouth at its top and a closed end opposite thereto. Often, the body portion is produced via blow-molding, which permits its formation in a wide variety of shapes with straight walls. However, blow-molding is less economically favorable than other production methods such as injection molding or vacuum forming. Once formed, the body portion is filled with powder through the mouth, then the cap is fit over the mouth.

Most dispensers employ a cap having two separate apertured elements that are twistingly engaged. When the apertured elements are aligned, powder or other particulate material can be dispensed. When the apertured elements are not aligned, the powder is retained in the container. apertured elements are not aligned, the powder is retained in the container. Examples of dispenser bottles are well-known in the art and disclosed at, for example, U.S. Pat. No. 4,488,668, Great Britain Des. 2041540, and U.S. Design Pat. No. Des. 349,858.

One problem associated with commercially available dispenser bottles is that they are relatively expensive to produce and fill. Another problem associated with commercially available dispenser bottles is that they tend to be inconvenient to use, based on their size.

Accordingly, there is a need for a simple, easy to assemble, low cost dispenser bottle that is convenient to use.

### SUMMARY OF THE INVENTION

The present invention provides a dispenser container for containing and selectively dispensing a flowable material comprising, consisting of, and/or consisting essentially of:

a) a body portion having an upper end and a lower end opposite thereto, the upper end having at least one aperture through which the flowable material passes when dispensed from the dispenser container;

b) an apertured cap overlying the upper end and engaged upon the body portion; and

c) a base plate,

wherein when the dispenser container is in a filling position, the lower end is open, and when the dispenser container is in a dispensing position, the base plate is secured to the body portion at the lower end.

Another embodiment of the present invention is directed to a method for assembling a dispenser container for containing and selectively dispensing a flowable material wherein the container comprises, consists of, and/or consists essentially of:

a) a body portion having an upper end and a lower end opposite thereto, the upper end having at least one aperture through which the flowable material passes when dispensed from the dispenser container;

b) a cap overlying the upper end and engaged upon the body portion; and

c) a base plate;

the method comprising, consisting of, and/or consisting essentially of the steps of:

a) filling the body portion engaged with the cap with a desired amount of flowable material through the lower end; and

b) securing the base plate to the lower end.

Yet another embodiment is directed to a dispenser container for containing and selectively dispensing a flowable material comprised of, consisting of, and/or consisting essentially of:

a) a body portion having an upper end and a lower end opposite thereto;

b) a base plate having at least one aperture through which the flowable material passes when dispensed from the dispenser container,

c) a thermoformed cap overlying the at least one aperture in the base plate, the cap having at least one aperture;

wherein when the dispenser container is in a filling position, the lower end opposite the outlet is open, and when the dispenser container is in a dispensing position, the base plate is secured to the body portion at the lower end.

Because the body portion may easily be filled via its lower end, the overall dispenser container may be produced and filled in a low cost, more efficient manner in comparison to that incurred in the production of prior art bottles.

### BRIEF DESCRIPTION OF THE DRAWINGS

The invention will be more fully understood and further advantages will become apparent when reference is made to the following detailed description of the invention and the accompanying drawings in which:

FIG. 1 is a perspective view of one embodiment of the dispenser bottle of the present invention.

FIG. 2 is an exploded perspective view of the dispenser bottle of FIG. 1, which is partially broken away to illustrate the interconnection between the various elements.

FIGS. 3A and 3B are top plan views showing the dispenser bottle of FIG. 1 in a dosed and an open position, respectively.

FIG. 4 is an exploded perspective view of an alternative embodiment of the dispenser bottle of FIG. 1, which has a flip top lid.

FIGS. 4A and 4B are top plan views showing the dispenser bottle of FIG. 4 in a closed and an open position, respectively.

FIG. 5 is an exploded perspective view of an alternative embodiment of the dispenser bottle of FIG. 1, which has a flip top lid and stop lugs.

FIGS. 5A and 5B are top plan views showing the dispenser bottle of FIG. 4 in a closed and an open position, respectively.

FIG. 6 is an exploded perspective view of an alternative embodiment of the dispenser bottle of FIG. 1, which has a flip top lid.

FIG. 7 is an exploded perspective view of an alternative embodiment of the dispenser bottle of FIG. 1, which has a flip top lid.

FIG. 8 is an exploded perspective view of an alternative embodiment of the dispenser bottle of FIG. 1, which has a two-piece, thermoformed cap assembly.

### DETAILED DESCRIPTION OF PREFERRED EMBODIMENTS

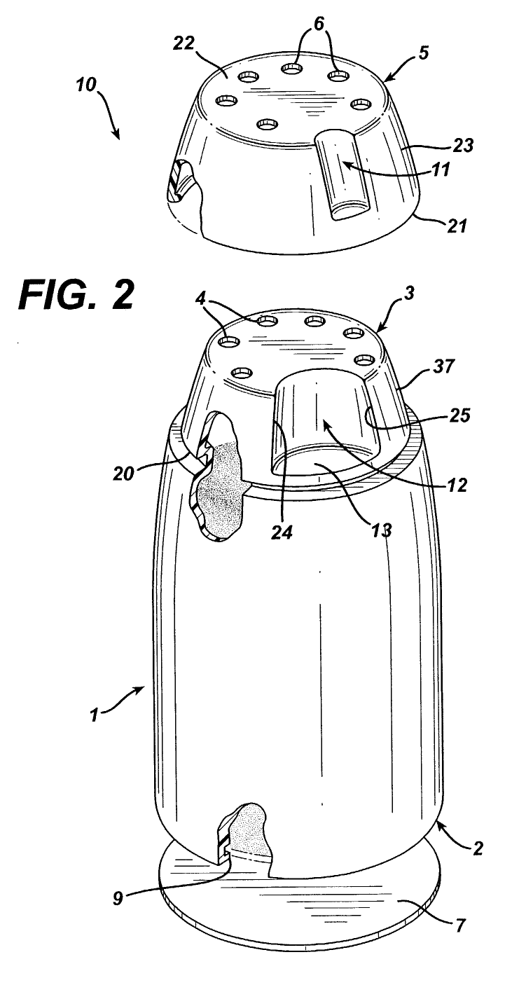

As shown in FIG. 2, one embodiment of the present invention is directed to a dispenser container 10 having a body portion 1 with an open lower end 2 and an upper end 3. Although the shape of the body portion 1 is not critical, it is advantageous from a filling perspective to have the diameter of the lower end 2 larger than the diameter of the upper end 3 as shown in FIG. 2.

The body portion 1 may be made by any process known in the art, such as by blow molding, as well as by more economical methods such as injection molding, thermoforming, and vacuum forming. The body portion 1 may be comprised of any suitable material known in the art. Suitable materials include, but are not limited to, polyethylene, polypropylene, polyvinyl chloride, polyethylene terephthalate, polystyrene, and polymers and blends thereof.

In one embodiment, the upper end 3 of the body portion 1 contains at least one aperture 4, or more preferably a plurality, for example from about 2 to about 20, of apertures 4 through which flowable material passes. The number, shape, size, and placement of the apertures 4 may vary depending upon, for example, the flowable material to be dispensed and the desired dispensing rate of the flowable material. In one embodiment, the apertures 4 are arranged in a circular pattern around the center of the upper end 3.

In this embodiment, a cap 5 is secured to the upper end 3 of the body portion 1. The cap 5 may be secured to the upper end 3, then the body portion 1 may be filled with the desired amount of flowable material. After the base plate 7 is attached to the lower end 2 of the body portion 1, at least one aperture 6 may then be made in the cap 5. Alternatively, at least one aperture 6 may be made in the cap 5 prior to its engagement with the upper end 3. In embodiments incorporating a cap 5 that is twistingly engaged with the upper end, the cap 5 may then be twisted such that the aperture 6 is not in alignment with the aperture 4 of the upper end 3 prior to filling. In embodiments incorporating a cap 5 with a flip top lid 8, the lid 8 may then be closed prior to filling.

The shape of the cap 5 is not critical, although its shape may be chosen on the basis of aesthetics and/or to functionally complement the configuration of the upper end 3. The cap 5 may be made by any process known in the art, such as blow molding, as well as by more economical methods such as injection molding, thermoforming, and vacuum forming.

The cap 5 contains at least one aperture 6, and more preferably a plurality, for example from about 2 to about 20, of apertures 6. The number, size, shape, and placement of the apertures 6 may vary depending upon, for example, the flowable material to be dispensed and the desired dispensing rate of the flowable material. The number and size of the apertures 6 on the cap 5 will typically be the same as the number and size of apertures 4 on the upper end 3 of the body portion 1.

In one embodiment, the apertures 6 are arranged in a circle about the center of the cap 5. In one embodiment, these apertures 6 have the shape of truncated cones, with the narrow portion terminating on the inside surface of the cap 5. This configuration facilitates the dispensing of fine particular materials. The cap 5 may be comprised of any suitable material known in the art. Suitable materials include, but are not limited to, polyethylene, polypropylene, polyvinyl chloride, polyethylene terephthalate, polystyrene, and copolymers and blends thereof.

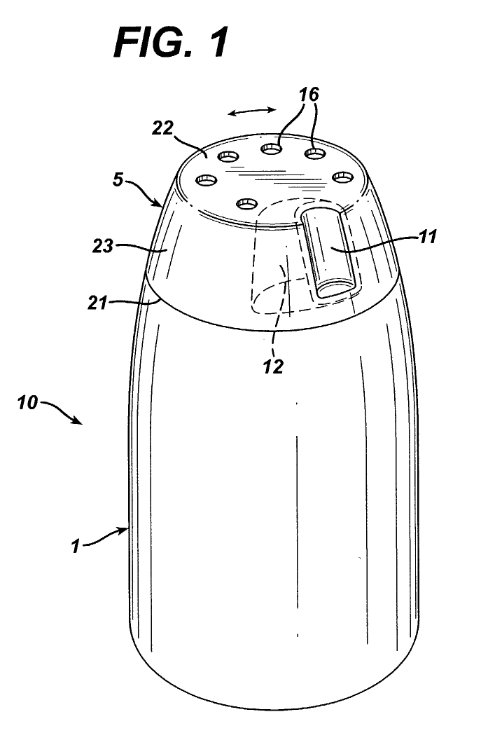

In the embodiment shown in, for example, FIGS. 1 and 2, the cap 5 is twistingly engaged with the upper end 3 of the body portion 1, such that the cap 5 contacts the flange 20 of the body portion 1. The cap 5 may be secured to the body portion 1 via any means known in the art that would enable the cap 5 and the body portion 1 to move in a twisting engagement. For example, the cap 5 may have a snap bead (not shown) extending around its circumference, which may be secured on to the powder dispersing end 3 of the body portion 1 such that the snap bead is in a twistingly engaged position with the flange 20.

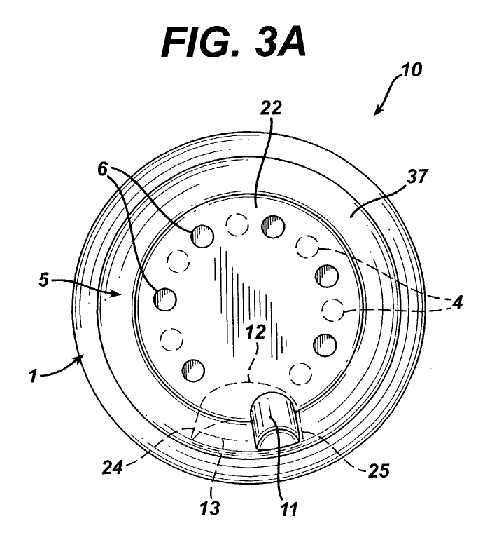

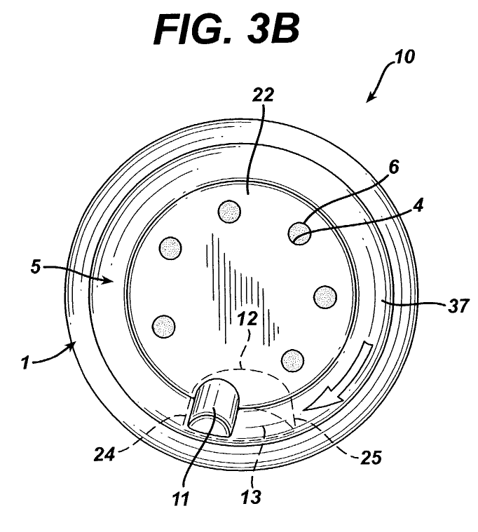

As shown in FIGS. 2, 3A, and 3B, a projection 11 depends from the underside of the top 22 of the cap 5, and corresponds with a corresponding recessed area 12 having a stop 13 within the upper end 3 of the body portion 1. Alternatively, the projection 11 may depend from the inner wall of the sidewalls 23 (not shown) of the cap 5. The combination of the projection 11 along with the recessed area 12 may be utilized to limit the rotation of the cap 5.

In an alternative embodiment (not shown), the projection 11 may depend from the upper end 3 or upper side wall 37 of the body portion 1, and the corresponding recessed area may be within the cap 5.

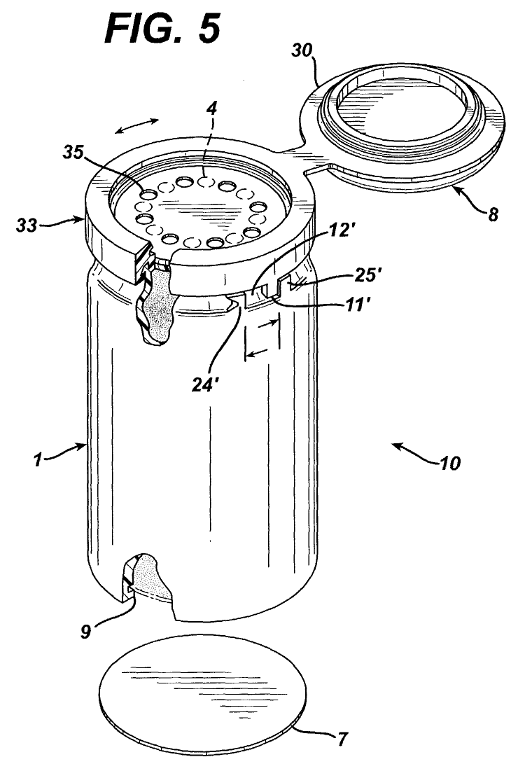

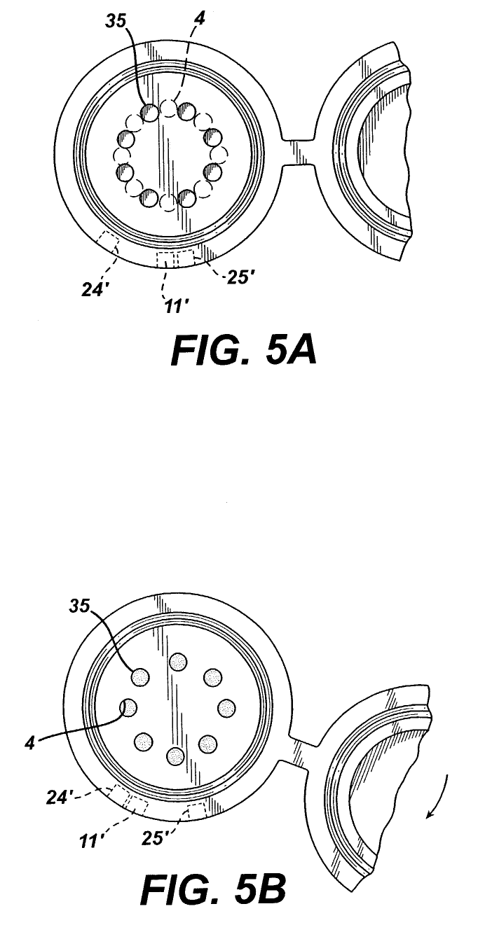

In yet another alternative embodiment as shown in FIGS. 5-5B, a projection 11′ may depend from the sidewalls 23 of a flip-top cap 8 and correspond to a recessed area 12′ in the body portion 1. The combination of the projection 11′ along with the recessed area 12′ may be utilized to limit the rotation of the cap 8.

As shown in FIG. 3A, the apertures 6 in the cap 5 are in the dosed, i.e., non-dispensing, position because they are not in alignment with the underlying apertures 4 in the upper end 3 of the body portion 1. This position is also suitable for filling the body portion 1 with the desired particular matter. In this position, it can be seen that the projection 11 abuts against one location on the sidewall 25 of the recessed area 12.

As shown in FIG. 3B, the apertures 6 in the cap 5 are in the open, i.e., dispensing, position because they are in alignment with the underlying apertures 4 in the upper end 3 of the body portion 1. In this position, it can be seen that the cap 5 was twisted in a clockwise manner such that the projection 11 bears against another location on the sidewall 24 of the recessed area 12.

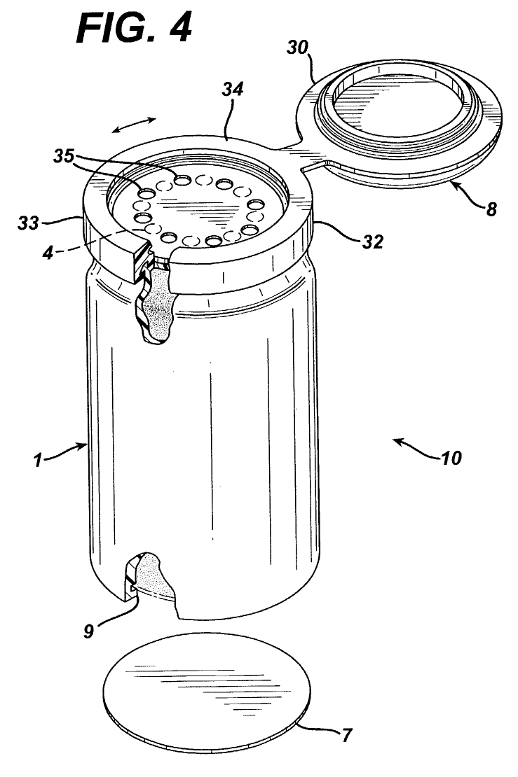

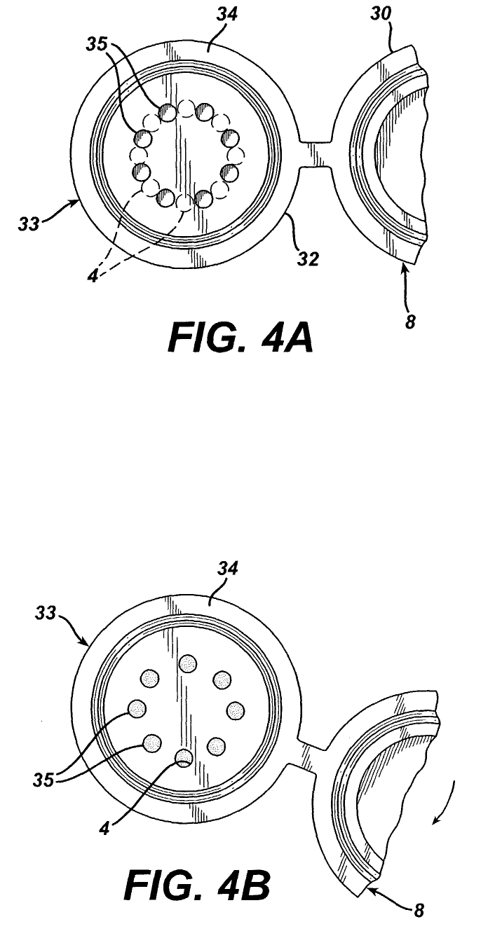

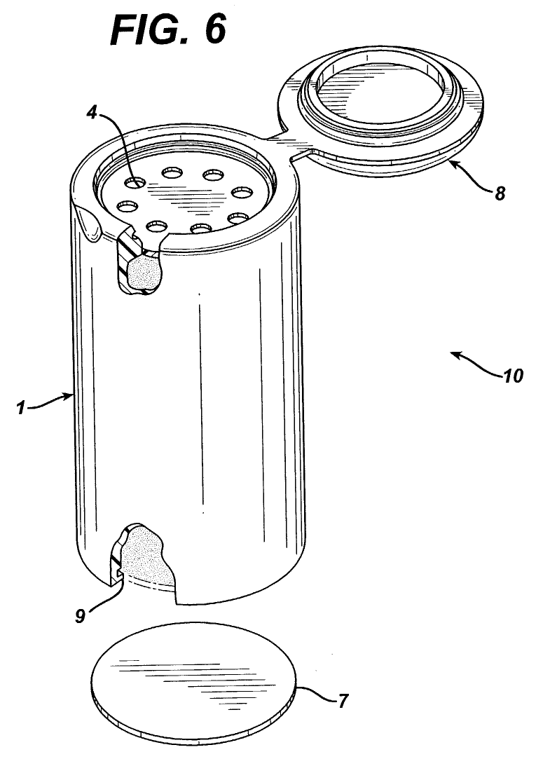

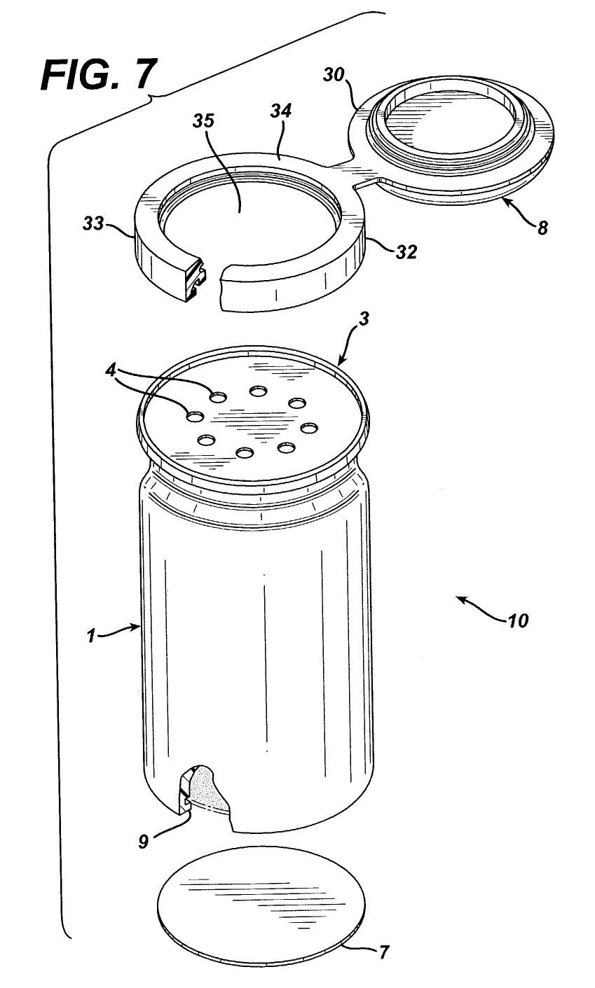

As shown in FIG. 4, the cap 5 may be replaced by a conventional flip top cap 8. In this embodiment, the flip top cap 8 may be twistingly engaged with the upper end of the body portion 1 as shown in, for example, FIGS. 5. 5A, and 5B, FIGS. 4, 4A, and 4B, and FIG. 7. Alternatively, a hinged lid 30 may be integral with the top surface 34 of the body portion 1 as shown in FIG. 6.

The flip top cap 8 may be of any conventional design known in the art, but is typically comprised of a cap base 33 and a hinged lid 30 integral with the side wall 32. The top surface 34 contains at least one opening 35, which may be an aperture, that may be aligned with at least one aperture 4 in the upper end 3 of the body portion 1. FIG. 7 shows the flip top cap 8 having at least one opening 35.

As shown for example in FIG. 4B and FIG. 5B, when the lid 30 is in the open position such that at least one aperture 35 of the flip top cap 8 is in alignment with at least one of the underlying apertures 4 in the upper end 3 of the body portion 1, the flowable material may be dispensed from the body portion 1.

As shown in, for example, FIG. 4A and FIG. 5A, when the apertures 35 of the flip top cap 8 are not in alignment with at least one of the underlying apertures 4 in the upper end 3 of the body portion 1, the flowable material may not be dispensed from the body portion 1. Alternatively, when the lid 30 is in the closed position (not shown), the flowable material within the body portion 1 may also be effectively contained within the body portion 1. This position is also suitable for filling the body portion 1 with the desired flowable material. Alternatively, the body portion 1 may be filled with the desired flowable material and the base plate 7 secured to the lower end of the body portion before apertures 4 are made in the upper end 3.

In one embodiment, the cap 5 or the flip top cap 8 may be snap fit onto the upper end 3 of the body portion 1 by way of any locking engagement by means known in the art, such as, for example, frictional engagement, snap bead on cap 5 secured to retaining ring on body portion 1, and the like. Alternatively, the cap 5 or the flip top cap 8 may contain internal threads (not shown) suitable for alignment with complementary threads (not shown) along the upper side walls 37 of the body portion 1 such that the cap 5 or flip top cap 8 may be twisted on and off of the body portion 1.

After the body portion 1 is filled with the desired flowable material, a base plate 7 is secured to the lower end 2 of the body portion 1. In one embodiment, the base plate 7 is secured to a flange 9 integral with the lower end 2 of the body portion 1. The base plate 7 may be made of any suitable material known in the art. Suitable materials include, but are not limited to, polyethylene, polypropylene, polyvinyl chloride, polyethylene terephthalate, polystyrene, and copolymers and blends thereof. Any means known in the art for securing the base plate 7 to the lower end 2 of the body portion 1 may be used. Suitable securing means include, but are not limited to, adhesives, ultrasonic welding, thermal bonding and the like. The thickness of the base plate 7 may vary depending upon various factors such as, for example, the type of flowable material in the body portion 1, and the desired durability of the resulting dispenser. However, in general the thickness of the base plate 7 may range from about 0.04 mil to about 0.85 mil.

In an alternative embodiment (not shown), after the body portion 1 is filled with the desired material, the open lower end 2 of the container may be dosed by crimping, heal sealing, or any another suitable closing method known in the art. Beneficially, this embodiment obviates the step of attaching a separate base plate 7 thereto. Optionally, a hanging means, such as a hook, may be attached to the lower end 2 of the container.

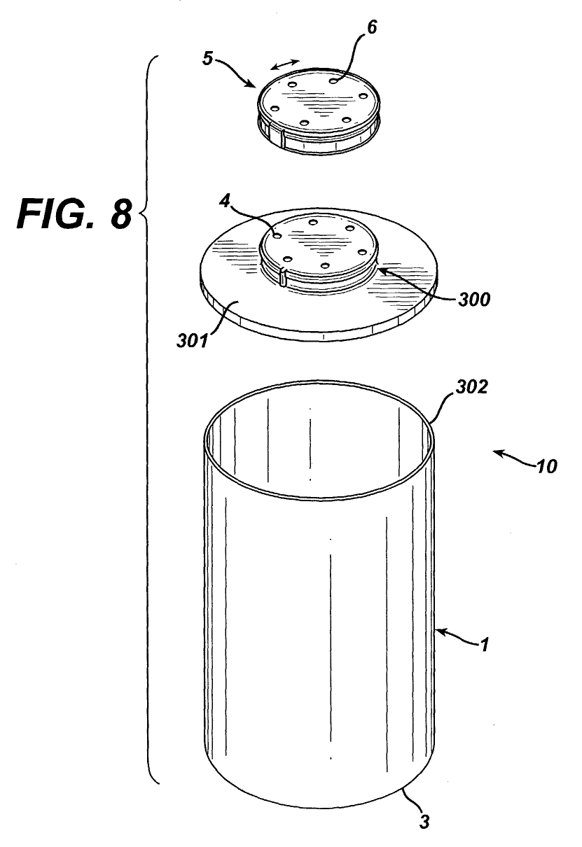

In yet another alternative embodiment (not shown), the upper end 3 of the body portion 1 is closed and does not contain an aperture 4. After the body portion 1 is inverted and filled with the desired amount of flowable material, the base plate 7 having at least one opening, e.g. aperture, may be secured to the flange 9 at the lower end 2 of the body portion 1. Alternatively, the base plate 7 may first be secured to the flange 9 at the lower end 2 of the body portion 1, then at least one opening may be formed therein. Any of the above-mentioned caps 5, which may be formed by methods known in the art, e.g. thermoforming, may optionally be secured to the open lower end 2 of the body portion 1, either with or without the attachment of the base plate 7 to the flange 9, via any of the aforementioned methods known in the art. FIG. 8 illustrates an inverted dispenser having a two piece, thermoformed cap, wherein the apertured portion 300 is integral with the base plate 301, and a second cap piece 5 is twistingly engaged therewith. The assembled, two-piece cap may then be attached to the lower end 302 of the body portion 1 after filling via any of the above-mentioned securing methods.

An example is set forth below to further illustrate the nature of the invention and the manner of carrying it out. However, the invention should not be considered as being limited to the details thereof.

### EXAMPLE

A polyvinyl chloride cup-shaped body portion having a lower end and an upper end was vacuum formed in the general shape shown in FIG. 1. Six apertures were formed in the upper end by puncturing the same with a punch. A polyvinyl chloride snap-on cap was formed by an injection molding process. Six apertures were formed in the cap by puncturing the same with a punch. The cap was snapped onto the upper end of the body portion, then twisted into a dosed, filling position such that the contents of the body portion could not dispensed therethrough. The capped body portion was placed on a surface and inverted, such that the open, lower end up was above the upper end. The body portion was then filled with a desired amount of JOHNSON's BABY® baby powder through the open lower end. A polyvinyl chloride base plate was placed over the lower end of the body portion and heat sealed thereto at a temperature of about 300° F.

We claim:

1. A dispenser container for containing and selectively dispensing a flowable material comprised of:
a) a body portion having an upper end and a lower end opposite thereto, the upper end having at least one aperture through which the flowable material passes when dispensed from the dispenser container;
b) a cap overlying the upper end and engaged upon the body portion, the cap having at least one aperture; and
c) a base plate,
wherein when the dispenser container is in a filling position, the lower end is open, and when the dispenser container is in a dispensing position, the base plate is secured to the body portion at the lower end.

2. The dispenser container of claim 1, wherein the upper end has a plurality of apertures.

3. The dispenser container of claim 1, wherein the cap is twistingly engaged with the upper end of the body portion.

4. The dispenser container of claim 3, wherein the cap further comprises a lid integrally connected to the cap via a hinge.

5. The dispenser container of claim 1, wherein the upper end has a recessed area, said recessed area having a sidewall with a first end and a second end, said cap having a projection depending downwardly into the recessed area, wherein when the projection abuts the first end, the dispensing container is in the dispensing position, and when the projection abuts the second end, the apertured cap is in the filling position.

6. A method for assembling a dispenser container for containing and selectively dispensing a flowable material wherein the dispenser container is comprised of:
a) a body portion having an upper end and a lower end opposite thereto, the upper end having at least one aperture through which the flowable material passes when dispensed from the dispenser container;
b) an cap overlying the upper end and engaged upon the body portion; and
c) a base plate;
the method comprising:
a) filling the body portion engaged with the cap with a desired amount of flowable material through the lower end; and
b) securing the base plate to the lower end.

7. The method of claim 6 further comprising puncturing the cap to form at least one aperture.

8. The method of claim 6 wherein the cap comprises at least one aperture.

9. A dispenser container for containing and selectively dispensing a flowable material comprised of:
a) a body portion having a closed upper end and a lower end opposite thereto;
b) a base plate having at least one aperture through which the flowable material passes when dispensed from the dispenser container,
c) a thermoformed cap overlying the at least one aperture in the base plate, the cap having at least one aperture;
wherein when the dispenser container is in a filling position, the lower end opposite the outlet is open, and when the dispenser container is in a dispensing position, the base plate is secured to the body portion at the lower end.
